(19) United States
(12) Patent Application Publication
(10) Pub. No.: US 2004/0034563 A1
(43) Pub. Date: Feb. 19, 2004

(54) System and method for making charitable donations

(76) Inventor: Edward C. Brissette, Medford, OR (US)

Correspondence Address: KOLISCH HARTWELL, P.C., 520 S.W. YAMHILL STREET, SUITE 200, PORTLAND, OR, 97204, US

(21) Appl. No.: 10/393,433

(22) Filed: Mar. 19, 2003

Related U.S. Application Data
(63) Continuation of application No. 09/443,090, filed on Nov. 18, 1999, now abandoned.
(63) Continuation of application No. 09/442,844, filed on Nov. 18, 1999, now abandoned.
(60) Provisional application No. 60/109,068, filed on Nov. 18, 1998.

(51) Int. Cl. G06F 17/60

(52) U.S. Cl. 705/14

(57) ABSTRACT

A plurality of donation articles are provided to allow a store's customers to make charitable donations. Each donation article corresponds to one or more charitable entities and includes an indicia designating a donation amount. The indicia on a customer-selected donation article is read to determine the donation amount. Optionally, the donation amount may be added to the customer's bill. Once the customer pays the bill, the store may transfer funds to the charitable entity corresponding to the donation amount on behalf of the customer.

### CROSS-REFERENCE TO RELATED APPLICATIONS

This application is a continuation of U.S. patent application Ser. No. 09/443,090, filed Nov. 18, 1999 and entitled “Scanner Donation Coupon” and a continuation of U.S. patent application Ser. No. 09/442,844, filed Nov. 18, 1999 and entitled “System and Method for Making Charitable Donations”, both of which claim priority to U.S. Provisional Patent Application Serial No. 60/109,068, filed Nov. 18, 1998 and entitled “Scanner Donation Coupon”.

### FIELD OF THE INVENTION

The present invention relates to charitable donations, and more particularly to a system and method that allows donors to make charitable donations easily, and that allows charitable entities to raise money efficiently.

### BACKGROUND

Charitable entities have worked to fulfill societal and humanitarian needs for hundreds, if not thousands, of years. While many charities rely on contributions of labor or goods to carry out their missions, most charities are supported, at least in part, by monetary donations from the public. However, charities typically must spend a portion of the donations they receive to publicize their activities and solicit additional donations. Charities may also incur substantial administrative costs associated with receiving donations, managing their staffs, complying with regulations, etc. Indeed, it can be difficult for charities to ensure that the major portion of the money they receive actually goes toward performing their charitable mission.

In addition to minimizing their administrative costs, charities also must work to maximize the donations they receive. One method for increasing donations is to solicit donations from a larger percentage of the public. Another method is to make it easier for potential donors to make a donation. For example, some charities place collection boxes near store or restaurant cash registers to encourage customers to donate their spare change.

This can be a particularly cost-effective method of fund-raising since it does not require a volunteer or paid employee to solicit the donation. However, this spare-change collection method may not be as effective for those customers who pay with personal checks, credit cards, debit cards, etc., since the customer typically does not receive any change during the transaction.

### SUMMARY OF THE INVENTION

The invention provides a system and method for allowing a store's customers to make charitable donations. The invention includes providing a plurality of donation coupons, each of which corresponds to one or more charitable entities and includes a computer-readable indicia designating a donation amount. A store computer is configured to read the indicia on a customer-selected donation coupon to determine the donation amount. Optionally, the donation amount may be added to the customer's bill. Once the customer pays the bill, the store may transfer funds to the charitable entity corresponding to the donation amount on behalf of the customer.

### BRIEF DESCRIPTION OF THE DRAWINGS

FIG. 1 is a schematic view of a system for allowing a store's customers to make charitable donations according to the present invention.

FIG. 2 is a donation coupon according to the present invention.

FIG. 3 is a flowchart illustrating a method for allowing a store's customers to make charitable donations according to the present invention.

### DETAILED DESCRIPTION

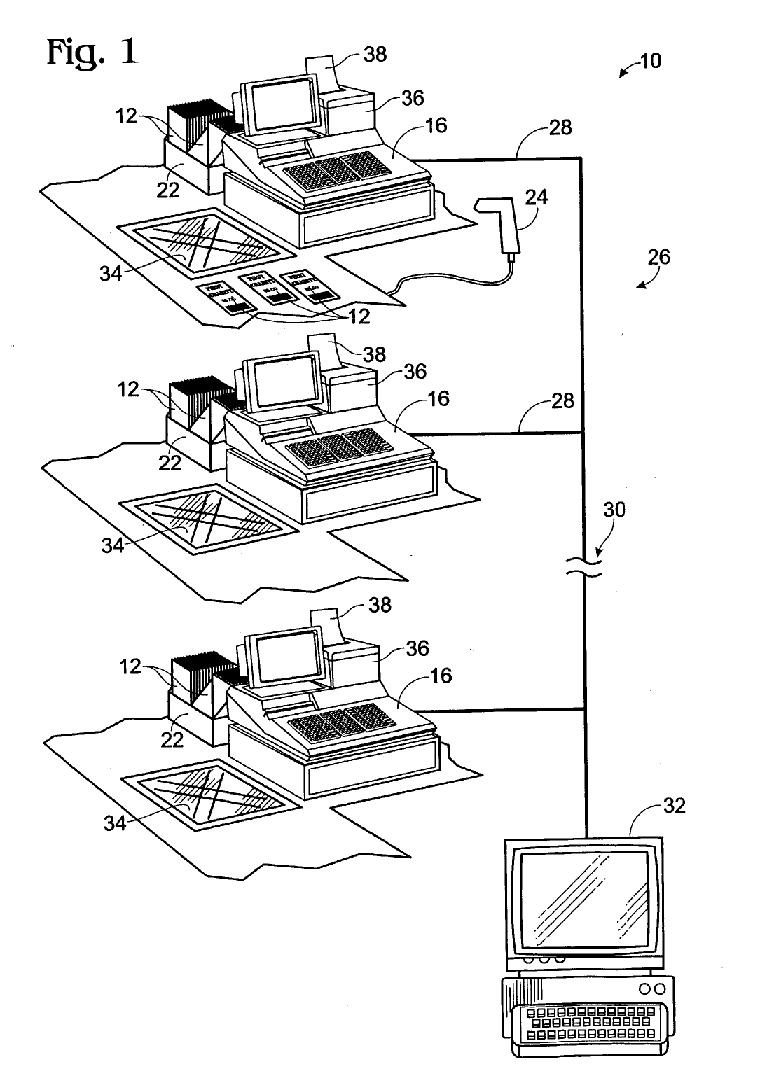

Referring to FIGS. 1 and 2, a system for allowing a store's customers to make charitable donations according to the present invention is indicated generally at 10. System includes a plurality of donation articles 12 displayable to the store's customers. Each article corresponds to one or more charitable entities and includes a computer-readable indicia 14 designating a donation amount. System 10 also includes one or more store computer systems 16 configured to read indicia 14 on a customer-selected donation article 12 to determine the donation amount designated by the article.

As will be described in further detail below, a customer may use system 10 to make a charitable donation by selecting a donation article, which is then read by computer system 16 to determine the designated donation amount. Alternatively, the indicia may be human-readable so that a store employee may read the indicia and enter the donation amount into computer system 16. Typically, the computer system adds the designated donation amount to the customer's bill. After the customer pays the bill, the store transfers funds to the charitable entity corresponding to the donation amount on behalf of the customer. Optionally, the store may encourage donations by offering to match at least a portion of the customer's donation by transferring additional funds to the selected charitable entity based on the donation amount.

As used herein, the term “charitable entity” includes any social, political, religious, humanitarian, or other entity that solicits donations from the public, regardless of whether the entity operates for profit or not-for-profit. Similarly, as used herein, the term “store” includes any wholesale, retail, or discount establishment that offers goods and/or services to the public.

It will be appreciated that donation article 12 may be implemented in any of a wide variety of forms including a coupon, a token, or any other suitable object. In the exemplary embodiment depicted in FIG. 2, article (hereinafter coupon) 12 includes a computer-readable first indicia 14 in the form of a bar code disposed thereon. The bar code designates, in a computer-readable form, a donation amount and one or more charitable entities. Bar code 14 may be compatible with any of the standard bar code formats which are well known to those of skill in the art, such as the Universal Product Code (UPC).

Coupon 12 may also include a human-readable second indicia 18 disposed thereon, which also designates the donation amount. This allows the customer/potential donor to ensure that the selected coupon designates the correct donation amount. Second indicia 18 also allows a store employee to read and determine the donation amount for manual entry into the store computer system. Coupon 12 may also include a human-readable third indicia 20 disposed thereon, which designates one or more charitable entities. Thus, the customer may confirm the selection of a coupon having both the desired donation amount and the desired recipient charitable entity.

In the exemplary embodiment, coupon 12 is printed on a relatively small, lightweight substrate such as paper, cardboard, plastic, etc., which may be carried by the customer to a selected computer system for scanning. Coupon 12 may be disposable, or it may be reusable by the same customer or by a plurality of customers. The coupons are displayed at various locations throughout a store, including in a display rack or structure 22 in the “check-out” aisle. Alternatively, the coupons may be distributed and displayed to potential donors in letters, newspapers, magazines, etc., in which case the donor simply brings the coupon along on their next shopping trip.

As a further alternative, coupon 12 may be relatively permanently mounted adjacent a computer system, as shown in the upper cashier station of FIG. 1. A customer may then indicate to the cashier that he or she wishes to make a donation corresponding to a selected coupon, and either the cashier or the customer would then scan the coupon using a hand-held scanner 24. In any event, a variety of coupons 12 may be displayed which designate a variety of different donation amounts and/or a variety of different recipient charitable entities. Thus, to make a particular donation, the customer simply selects the appropriate coupon designating the desired charity and the desired donation amount.

In the exemplary embodiment, system 10 includes a network 26 of interconnected store computer systems 16. One or more of the computer systems may take the form of a cash register such as is well known in the art. The computer systems may be connected through an actual hard-wired connection 28, or may be connected through wireless connections 30. In addition, computer systems 16 may also be connected to one or more central store computers 32 configured to manage and supervise the network and computer systems 16. It will be appreciated that central computer 32 may be a personal computer, a workstation, a mainframe, etc., and may be implemented on a single device or distributed across a plurality of networked systems. Similarly, network 26 may include one or more computer systems in only a single store, or may include a plurality of computer systems disposed in a plurality of remotely distributed stores. Each of computer systems 16 and central computers 32 include appropriate software executable thereon to carry out assigned functions such as reading and interpreting bar codes, totaling bills, calculating total donations, creating reports, transferring funds, etc.

Each computer system 16 includes a bar code reader such as stationary scanner 34 or hand-held scanner 24. As is well known to those of skill in the art, these bar code readers typically use optical signals to scan and read the bar codes. The computer systems and bar code readers are used to record a customer's purchases and calculate the customer's bill. Similarly, when a customer selects a donation coupon to make a charitable donation, the coupon is read by the computer system and added to the customer's bill. Thus, regardless of whether the customer pays with cash, check, credit card, debit card, etc., the customer can make a donation at the same time that they pay for their purchases.

Computer system 16 also includes a printer 36 or similar device to provide the customer with a receipt 38 for the bill. Included on the receipt is an indication of the charitable donation which the customer may keep as part of their tax records. In the exemplary embodiment, receipt 38 is a single receipt listing both the charitable donation as well as the customer's purchases. Alternatively, computer system 16 and printer 36 may be configured to print separate receipts for the donation and the purchases.

Once the customer has paid the bill, the store may transfer funds to the selected charitable entity corresponding to the donation amount. The funds transfer may be executed by any suitable means including cash, check, electronic transfer, etc. In the exemplary embodiment, the store does not execute the transfer after each donation. Rather, to save time and expense, the store records or tracks each donation and adds it to a donation total. Where donations are made to multiple charitable entities, the store tracks donation totals for each entity. At selected intervals, the store transfers funds equal to the donation total to the corresponding charitable entity. This method allows the store to verify that each donor's payment has cleared before relaying the donation to the charitable entity.

Typically, the information read from the donation coupons is stored in a database system (not shown) accessible by at least one of computer system 16 or central computer 32. The donation amount is added to the donation total for the corresponding charitable entity and stored on the database system. In addition to transferring funds at selected intervals, the store may also provide a report including the current donation total to the corresponding charity. The report may be made at the charity's request or at selected intervals. The report allows the charitable entity to monitor donations and make budgetary plans prior to receiving the funds from the store.

Alternatively, transfers may be executed for each donation. For example, computer system 16 may be configured to execute a direct electronic funds transfer from the customer's account to the charitable entity's account. Alternatively, the store may make the transfer from its own funds after receiving the customer's payment.

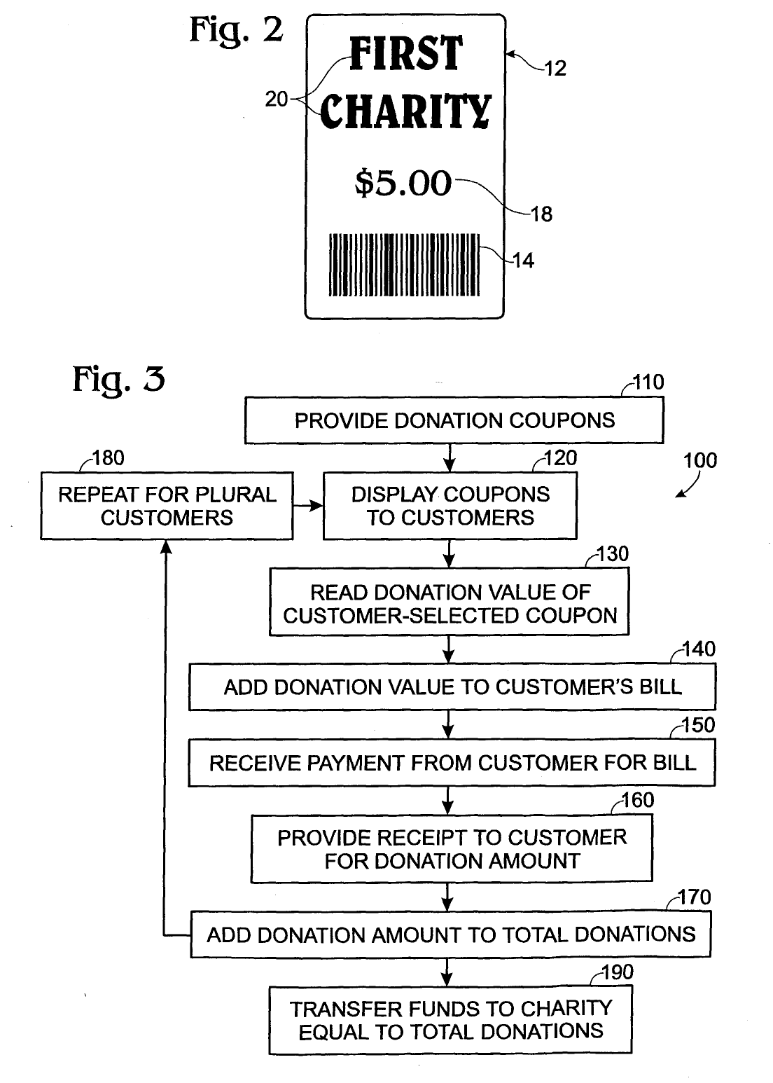

As described above, system 10 provides a method for raising funds for charity, as indicated generally at 100 in FIG. 3. Method 100 includes, at step 110, providing a plurality of donation coupons 12. The coupons are displayed to the store's customers via in-store displays, mail, newspapers, magazines, etc., as indicated at 120. Once a customer has selected a donation coupon, the coupon is scanned to determine the donation amount, as indicated at 130.

While it is not necessary that a customer make purchases along with a donation, typically the customer will take advantage of the chance to make a charitable donation at a time when they are also making purchases. Thus, once the donation amount is determined, it is added to the customer's bill, as indicated at 140. After all the purchases are entered and the donation coupon(s) are scanned, the bill is totaled and the store receives a payment from the customer for the bill amount, as indicated at 150. Thus, the customer is able to make one payment to cover both the purchases and the donation. Typically, the store will provide a receipt to the customer, as indicated at step 160. The receipt may be for the donation amount only, or it may also include a receipt for the purchases as well.

Typically, the donation amount is added to a total donation value stored within the store's database system, as indicated at 170. Where plural charitable entities receive donations, the donation amount is added to the total donation value corresponding to the designated charity. Steps 120 through 170 may be repeated for a plurality of customers, as indicated at 180. At selected intervals, the store transfers funds to the charitable entity corresponding to the current value of total donations, as indicated at 190. The value for total donations is then reset to zero. Optionally, the store can provide reports of the current donation total to the charity at selected times between transfers.

It will be appreciated that the system and method described above provides charities with a highly effective means of raising funds. By placing the donation coupons adjacent a store's cash registers, a charity is able to benefit from a customer's “impulse donation.” Moreover, the scanner coupons allow the charity to receive donations even when the customer does not receive change back from a purchase. Additionally, the charity receives tremendous exposure to potential donors since virtually every customer will see the coupons when making their purchases. This is especially true where the charity places donation coupons in each store of a national chain. For example, assume a charity places donation coupons adjacent every cash register in a store chain with 250 outlets and an average of 9 registers per outlet. Even if the average register only executed $5.00 in donations per day, the total donations per day would be $11,250.00, yielding over $300,000.00 per month.

The system and method described above also provide an extremely efficient, low-overhead means of raising funds. Once the coupons are printed and placed in stores, no further labor is required by the charity. The store's employees record the donations while scanning the customer's purchases. The only responsibility of the charity is to ensure that donation coupons remain available for customers. Thus, the charity can focus its resources on its mission rather than fund raising.

The invention may also be described as recited in the following paragraphs:

A method for allowing a store's customers to make donations to a charitable entity, including the steps of: providing a plurality of portable donation articles, each article having an indicia designating a donation amount; displaying the plurality of donation articles to a store's customers; reading the indicia on a customer-selected donation article to determine the donation amount designated by the customer-selected donation coupon; receiving a payment from the customer; and on behalf of the customer, transferring funds to the charitable entity corresponding to the donation amount.

The above method may further include the steps of determining a bill amount corresponding to a customer's purchases, and adding the donation amount to the bill amount, and wherein the step of receiving includes receiving a payment from the customer corresponding to the bill amount.

A method for allowing a store's customers to make donations to a charitable entity, including the steps of: providing a plurality of donation articles, each article having a computer-readable indicia designating a donation amount; displaying the plurality of donation articles to a store's customers; reading the indicia on a customer-selected donation article with a computer to determine the donation amount designated by the customer-selected donation article; receiving a payment from the customer; and on behalf of the customer, transferring funds to the charitable entity corresponding to the donation amount.

The above method may be performed according to several alternate variations including the following which involve using the additional steps of: (1) steps of: determining a bill amount corresponding to a customer's purchases, and adding the donation amount to the bill amount, and wherein the step of receiving includes receiving a payment from the customer corresponding to the bill amount; (2) performing the steps of providing, displaying, reading, and receiving for each of plural customers, adding the donation amount corresponding to each of the plural customers to a donation total, and on behalf of the plural customers, transferring funds to the charitable entity corresponding to the donation total; (3) determining a current donation total at selected intervals and reporting the current donation total to the charitable entity; (4) providing includes providing one or more articles designating a first donation amount, and providing one or more articles designating a second donation amount different than the first donation amount; (5) displaying includes displaying the articles adjacent the computer; (6) displaying includes displaying the articles adjacent each of a plurality of computers within the store; (7) reading includes reading the indicia on a plurality of articles using the plurality of computers within the store; (8) adding the donation amount designated by each of the plurality of articles to a donation total, and transferring funds to the charity corresponding to the donation total; (9) of displaying includes mailing an article to the customer; (10) providing the customer with a receipt for the donation amount; (11) providing includes providing a donation article having a computer-readable bar code designating a donation amount, and wherein the step of reading includes reading the bar code with a bar code reader operatively connected to the computer; and (12) matching the customer's donation by transferring additional funds to the charity based on the donation amount.

A store-based system for executing transactions involving charitable donations by the store's customers, including : a plurality of donation articles, each article corresponding to one or more charitable entities and including a computer-readable indicia designating a donation amount; and at least one store computer system configured to read the indicia on a selected donation article to determine the designated donation amount.

The above system may also include several alternate components including the following: (1) a store display structure adapted to display the articles to the store's customers; (2) the computer system being configured to add the donation amount to a customer's bill; (3) the plurality of donation articles including one or more articles designating a first donation amount, and one or more articles designating a second donation amount different from the first donation amount; (4) the plurality of donation articles including one or more articles designating a first charitable entity, and one or more articles designating a second charitable entity different than the first charitable entity; (5) the plurality of donation articles including one or more articles designating a plurality of charitable entities; (6) a network of computer systems configured to read the indicia on a plurality of selected donation articles to determine the corresponding donation amounts; (7) the network being configured to maintain a donation total by adding the corresponding donation amounts together; (8) the network being configured to transfer funds corresponding to the donation total to a selected charitable entity; (9) at least one store computer system including a cash register; (10) the computer-readable indicia including a bar code, with the at least one computer system including a bar code reader; and (11) at least one of the donation articles including a human-readable indicia designating the donation amount.

A device for making a donation to charity, comprising an article displayable to one or more potential donors, wherein the article includes a computer-readable first indicia disposed thereon, the first indicia designating an amount to be donated, and wherein article also includes a human-readable second indicia disposed thereon, the second indicia also designating the amount to be donated, and wherein the article is usable by a potential donor to make a charitable donation equal to the donation amount.

The above device may also include several alternate components including the following: (1) the first indicia designating one or more charitable entities; (2) the article including a human-readable third indicia designating one or more charitable entities; (3) the first indicia including a bar code; (4) the article being disposable; (5) the article being reusable; and (6) the article being displayable to potential donors in at least one of a letter, a magazine, and a newspaper.

While the invention has been disclosed in its preferred form, the specific embodiments thereof as disclosed and illustrated herein are not to be considered in a limiting sense as numerous variations are possible. Applicant regards the subject matter of the invention to include all novel and non-obvious combinations and subcombinations of the various elements, features, functions and/or properties disclosed herein. No single feature, function, element or property of the disclosed embodiments is essential to all embodiments. The following claims define certain combinations and subcombinations which are regarded as novel and non-obvious. Other combinations and subcombinations of features, functions, elements and/or properties may be claimed through amendment of the present claims or presentation of new claims in this or a related application. Such claims, whether they are different, broader, narrower or equal in scope to the original claims, are also regarded as included within the subject matter of applicant's invention.

I claim:

1. A method for allowing a store's customers to make donations to a charitable entity, comprising:
providing a plurality of donation articles, each article having a computer-readable indicia designating a donation amount;
displaying the plurality of donation articles to a store's customers;
reading the indicia on a customer-selected donation article with a computer to determine the donation amount designated by the customer-selected donation article;
receiving a payment from the customer; and
on behalf of the customer, transferring funds to the charitable entity corresponding to the donation amount.

2. The method of claim 1, further comprising the steps of
determining a bill amount corresponding to a customer's purchases, and adding the donation amount to the bill amount,
and wherein the step of receiving includes receiving a payment from the customer corresponding to the bill amount.

3. The method of claim 1, further comprising
performing the steps of providing, displaying, reading, and receiving for each of plural customers,
adding the donation amount corresponding to each of the plural customers to a donation total, and
on behalf of the plural customers, transferring funds to the charitable entity corresponding to the donation total.

4. The method of claim 1, wherein the step of providing includes providing one or more articles designating a first donation amount, and providing one or more articles designating a second donation amount different than the first donation amount.

5. The method of claim 1, wherein the step of displaying includes displaying the articles adjacent the computer.

6. The method of claim 5, wherein the step of displaying includes displaying the articles adjacent each of a plurality of computers within the store.

7. The method of claim 6, wherein the step of reading includes reading the indicia on a plurality of articles using the plurality of computers within the store.

8. The method of claim 7, further comprising the steps of adding the donation amount designated by each of the plurality of articles to a donation total, and transferring funds to the charity corresponding to the donation total.

9. The method of claim 1, further comprising the step of providing the customer with a receipt for the donation amount.

10. A store-based system for executing transactions involving charitable donations by the store's customers, comprising:
a plurality of donation articles, each article corresponding to one or more charitable entities and including a computer-readable indicia designating a donation amount; and
at least one store computer system configured to read the indicia on a selected donation article to determine the designated donation amount.

11. The system of claim 10, wherein the computer system is configured to add the donation amount to a customer's bill.

12. The system of claim 10, wherein the plurality of donation articles includes one or more articles designating a first donation amount, and one or more articles designating a second donation amount different from the first donation amount.

13. The system of claim 10, wherein the plurality of donation articles includes one or more articles designating a first charitable entity, and one or more articles designating a second charitable entity different than the first charitable entity.

14. The system of claim 10, further comprising a network of computer systems configured to read the indicia on a plurality of selected donation articles to determine the corresponding donation amounts.

15. The system of claim 14, wherein the network is configured to maintain a donation total by adding the corresponding donation amounts together.

16. The system of claim 15, wherein the network is configured to transfer funds corresponding to the donation total to a selected charitable entity.

17. The system of claim 10, wherein the at least one store computer system includes a cash register.

18. The system of claim 10, wherein the computer-readable indicia includes a bar code, and wherein the at least one computer system includes a bar code reader.

19. The system of claim 10, wherein at least one of the donation articles includes a human-readable indicia designating the donation amount.

20. A device for making a donation to charity, comprising an article displayable to one or more potential donors, wherein the article includes a computer-readable first indicia disposed thereon, the first indicia designating an amount to be donated, and wherein article also includes a human-readable second indicia disposed thereon, the second indicia also designating the amount to be donated, and wherein the article is usable by a potential donor to make a charitable donation equal to the donation amount.
